(19) United States
(12) Patent Application Publication
(10) Pub. No.: US 2007/0030583 A1
(43) Pub. Date: Feb. 8, 2007

(54) Color wheel

(76) Inventor: Huan-Tsung Lin, Chu Nan (TW)

Correspondence Address: CHRISTIE, PARKER & HALE, LLP, PO BOX 7068, PASADENA, CA, 91109-7068, US

(21) Appl. No.: 11/497,650

(22) Filed: Aug. 1, 2006

(30) Foreign Application Priority Data
Aug. 4, 2005 (TW) 094126587

(51) Int. Cl. G02B 7/00

(52) U.S. Cl. 359/892

(57) ABSTRACT

A color wheel includes a rotating shaft extending upwardly from a support face and having an engaging portion formed on the rotating shaft. A color filter plate set is disposed around the rotating shaft over the support face and includes a plurality of angularly arranged color filter plates. A first pressing ring is disposed between the color filter plate set and the support face. A second pressing plate is sleeved around the rotating shaft over the color filter plate set, and a fixing member is disposed around the rotating shaft over the second pressing plate. The fixing member engages the engaging portion and presses the second pressing plate and the color filter plate set so that the color filter plate set is prevented from moving outwardly from the support face.

### CROSS-REFERENCE TO RELATED APPLICATION

This application claims priority from Taiwanese Utility Application No. 94126587 filed on Aug. 4, 2005.

### BACKGROUND OF THE INVENTION

1. Field of the Invention

The invention relates to a color wheel, more particularly to a color wheel used in a projection device.

2. Description of the Related Art

A color wheel for a projection device includes a plurality of color filter plates which are rotated at high speed through a motor for the separation of colors from a white light passing therethrough. The separated different colors are then synthesized by another optical element of the projection device to produce a full color image.

Referring to FIGS. 1 and 2, a conventional color wheel 1 is shown to include a drive unit, a color filter plate assembly 12 mounted on the drive unit, and a packing ring 13 disposed over the color filter plate assembly 12. The drive unit, such as a motor 11 includes a rotary housing 111, and a rotating shaft 112 extending outwardly from the center of the rotary housing 111. The color filter plate assembly 12 includes six truncated sector-shaped color filter plates 121. The color filter plates 121 are juxtaposed with each other to form the color filter assembly 12 in a ring-shape. Each color filter plate 121 is adhered to a top surface of the rotary housing 111 through glue applied to a bottom side thereof.

The packing ring 13 is sleeved around the rotating shaft 112 and abuts against the color filter plate assembly 12. The inner peripheral edge of the packing ring 13 is glued and fixed to the rotating shaft 112. The glue is applied to the rotary housing 111 and the rotating shaft 112 through a manual operation, and a tool (not shown) is needed to adhere the filter plates 121 and the packing ring 13 to the rotary housing 111 and the rotating shaft 112 respectively. However, the manual operation is liable to entail disuniform application of the glue which leads to unevenness on the top surface of the rotary housing 111 so that it is difficult to adhere the color filter plates 121 neatly and smoothly to the top surface of the rotary housing 111. Even the glue leaks out of the top surface of the rotary housing 111.

On the other hand, since the high-speed rotation of the motor 11 tends to produce heat and change the adhesion properties of the glue, the color filter plates 121 or the glue is spun away from the rotary housing 111 during the rotation of the rotary housing 111.

Moreover, since glue generally has low thermal conductivity and a clearance is disposed between the packing ring 13 and the color filter plates 121, a temperature difference is produced between the glued bottom surface and the un-glued top surface of the color filter plates 121. Thermal stress resulting from the temperature difference leads to a breakage of the filter plates 121 under the high-speed rotation thereof. Furthermore, since the filter plates 121 are assembled by applying high pressure to the filter plates 121 through the tool (not shown), damage is caused to the small size motor 11. Furthermore, when the assembly fails, components of the color wheel cannot be recycled.

### SUMMARY OF THE INVENTION

Therefore, an object of the present invention is to provide a color wheel that promotes evenness and stability of a color filter plate set thereof.

Another object of the present invention is to provide a color wheel that prevents color filter plates thereof from breaking under thermal variation.

Yet another object of the present invention is to provide a color wheel that ensures assembly quality and permits easy replacement and recycling of components.

Accordingly, a color wheel according to the present invention comprises a driving unit that includes a support face, a rotating shaft protruding upwardly from a center of the support face, and an engaging portion formed on the rotating shaft. The color wheel further comprises: a first pressing plate disposed around the rotating shaft and on the support face; a color filter plate set disposed around the rotating shaft and on the first pressing plate and including a plurality of angularly arranged color filter plates; a second pressing plate sleeved around the rotating shaft over the color filter plate set; and a fixing member disposed around the rotating shaft. The fixing member engages the engaging portion to press the second pressing plate, the color filter plate set, and the first pressing plate against the support face so as to prevent the color filter plate set from moving outwardly from the support face.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic sectional view of a conventional color wheel;

FIG. 2 is a schematic top view of a conventional color wheel;

FIG. 3 is a sectional view of a color wheel according to the first preferred embodiment of the present invention;

FIG. 4 is an exploded view of the first preferred embodiment;

FIG. 5 is a top view of the first preferred embodiment;

FIG. 6 is a top view showing one color filter plate of the first preferred embodiment;

FIG. 7 is a top view showing a second pressing plate and a color filter plate set of the first preferred embodiment;

FIG. 8 is the same view as FIG. 7, but showing the color filter plates provided with semicircular holes;

FIG. 9 is the same view as FIG. 7, but showing the color filter plates provided with arc-shaped holes;

FIG. 10 is a partially sectioned schematic view of a second preferred embodiment of the present invention;

FIG. 11 is an exploded view of the second preferred embodiment;

FIG. 12 is a top view of the second preferred embodiment;

FIG. 13 shows the pressing ring of the second preferred embodiment;

FIG. 14 is a sectional view of a third preferred embodiment of the present invention;

FIG. 15 is an exploded view of the third preferred embodiment; and

FIG. 16 is a top view of the third preferred embodiment.

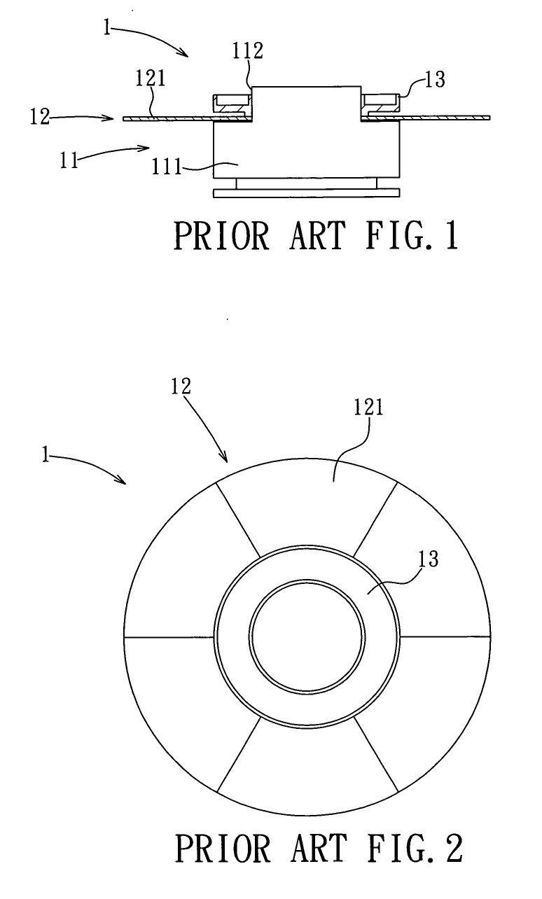

### DETAILED DESCRIPTION OF THE PREFERRED EMBODIMENTS

Before the present invention is described in greater detail with reference to the accompanying preferred embodiments, it is noted herein that like elements are denoted by the same reference numerals throughout the disclosure.

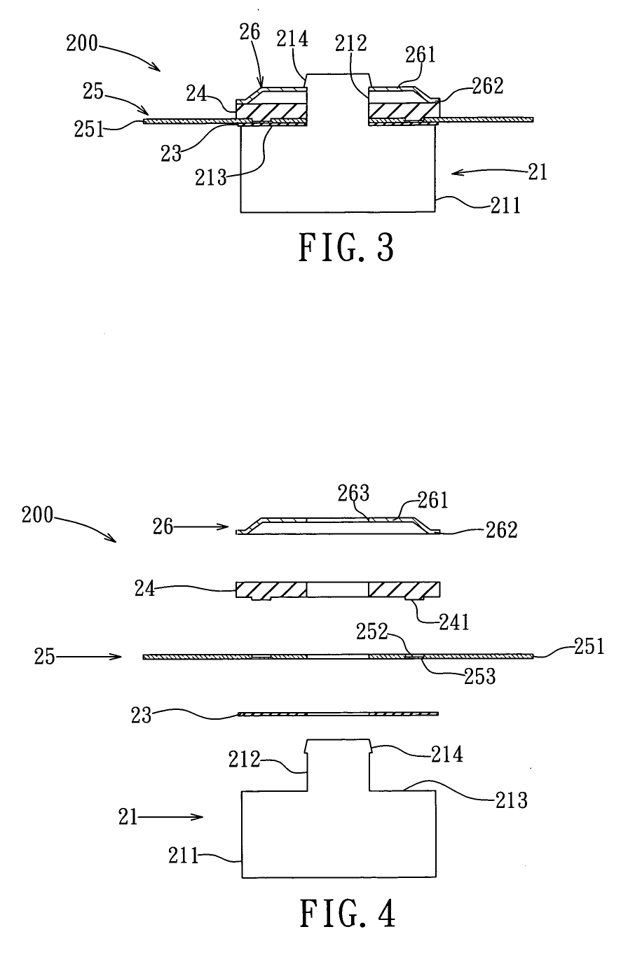

Referring to FIGS. 3, 4, and 5, according to the first preferred embodiment of the present invention, a color wheel 200 comprises a driving unit 21, a first pressing plate 23, a color filter plate set 25, a second pressing plate 24 and a fixing member 26.

The driving unit 21 is a motor that includes a rotary housing 211, a support face 213 formed on a top side of the rotary housing 211, and a rotating shaft 212 protruding upwardly from the center of the support face 213. The driving unit 21 further has an engaging portion 214, which is formed around a top end of the rotating shaft 212. The engaging portion 214 in the embodiment is a barb, which protrudes laterally and outwardly from the rotating shaft 212.

The first pressing plate 23 is disposed on the support face and between the color filter plate set 25 and the support face 213. The first pressing plate 23 is sleeved around the rotating shaft 212.

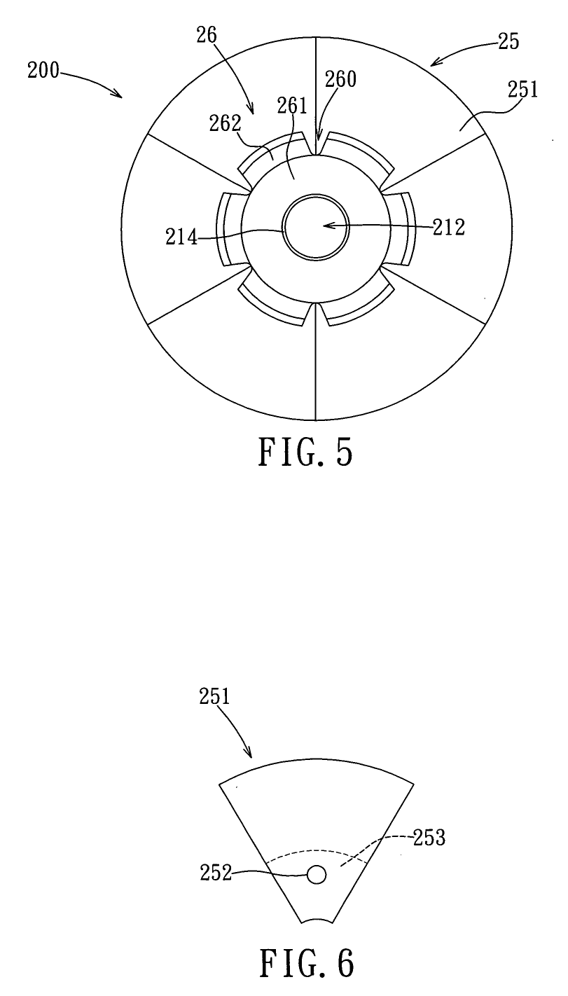

Further referring to FIGS. 5, 6, and 7, the color filter plate set 25 includes six truncated sector-shaped color filter plates 251 juxtaposed with each other, arranged annularly, and disposed around the rotating shaft 212 and over the first pressing plate 23 and the support face 213. The color filter plates 251 include a pair of red filter plates, a pair of green filter plates and a pair of blue filter plates. Each of the color filter plates 251 has a top face formed with a first coupling element 252 in the form of a substantially circular blind hole proximate to the rotating shaft 212. The bottom face of the each color filter plate 251 has a roughened surface region 253 to contact and interfere with the top face of the first pressing plate 23.

The second pressing plate 24 is sleeved around the rotating shaft 212 over the color filter plate set 25, and has a plurality of second coupling elements 241 in the form of substantially circular protrusions, which are spaced apart angularly on a bottom side of the second pressing plate 24 to engage the respective first coupling elements 252, such as blind holes, in the embodiment. Through the roughened surface region 253 of the color filter plates 251 engaging with the top side of the first pressing plate 23 and through the circular protrusions of the second coupling elements 241 engaged with the first coupling elements 252 of the color filter plates 251, each color filter plate 251 is held firmly between the second pressing plate 24 and the first pressing plate 23 on the support face 213 of the rotary housing 211.

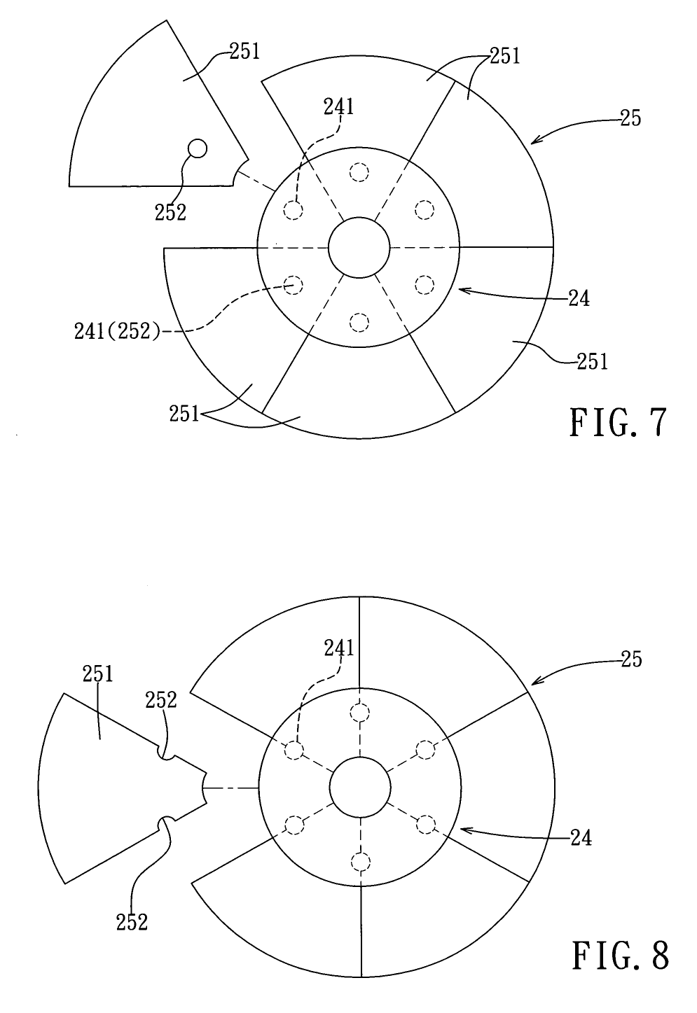

In an alternative shown in FIG. 7, the first coupling elements 252 are circular through holes to engage the respective second coupling elements 241 formed as circular studs so as to couple together the second pressing plate 24 and the color filter plates 251.

In another alternative shown in FIG. 8, each color filter plate 251 is provided with two first coupling elements 252, such as a pair of semicircular holes, on two lateral sides thereof. The second coupling elements 241 are circular protrusions each disposed on the second pressing plate 24 at a location corresponding to a border line between two adjacent color filter plates 251 to engage one pair of the semicircular holes.

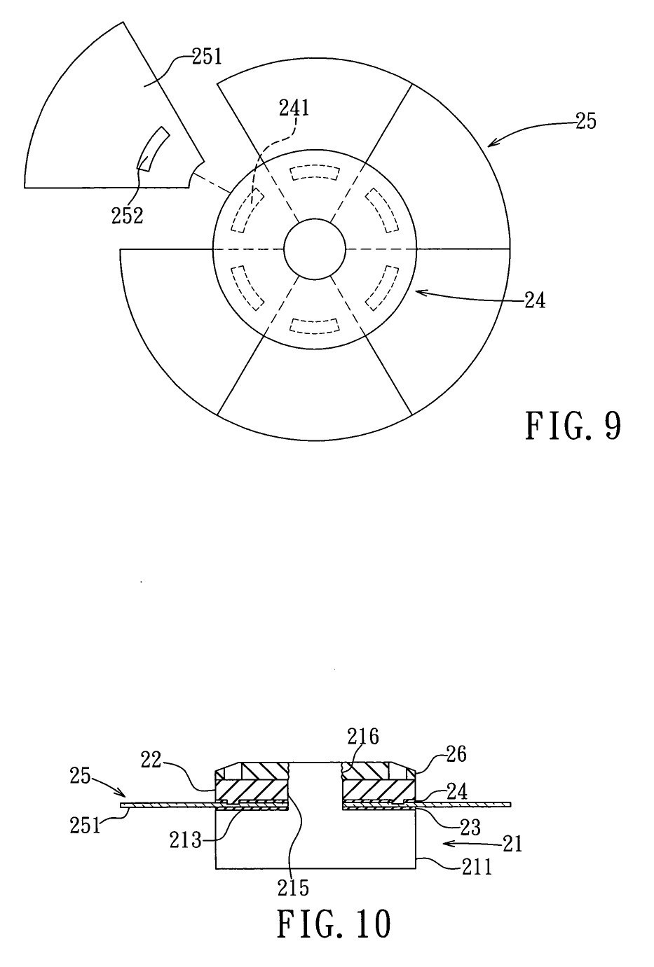

In still another alternative shown in FIG. 9, each first coupling element 252 is an arc-shaped hole, and each second coupling element 241 is an arc-shaped protrusion to engage with the arc-shaped hole of the respective first coupling element 252.

Preferably, the first pressing plate 23 and the second pressing plate 24 are both made of a thermoplastic material which possesses a high friction coefficient and a high temperature resistance, so that heat produced upon the high-speed rotation of the driving unit 21 does not affect the characteristics of the first pressing plate 23 and the second pressing plate 24. On the other hand, the high friction coefficient material increases stability of the color filter plate set 25 and the first pressing plate 23 and prevents the color filter plate set 25 from moving away from the second pressing plate 24 and the first pressing plate 23.

Referring once again to FIGS. 4 and 5, the fixing member 26 is disposed around the rotating shaft 212 and disposed between the second pressing plate 24 and the engaging portion 214. The fixing member 26 is engaged with the engaging portion or the barb 214 of the rotating shaft 212. In particular, the fixing member 26 includes a resilient annular disk 261 having an inner edge 263 which defines a central hole and which engages with the barb 214. The resilient annular disk 261 is spaced from the top side of the second pressing plate 24 and includes six resilient tabs 262. The resilient tabs 262 are split from each other by clearances 260 and project outwardly and downwardly from a periphery of the annular disk 261 to abut against the top side of the second pressing plate 24, thereby pressing firmly the second pressing plate 24, the color filter plate set 25 and the first pressing plate 23 against the support face 213 and preventing the color filter plate set 25 from moving relative to the second pressing plate 24 and the support face 213 and preventing the color filter plate set 25 from moving outwardly from the support face 213.

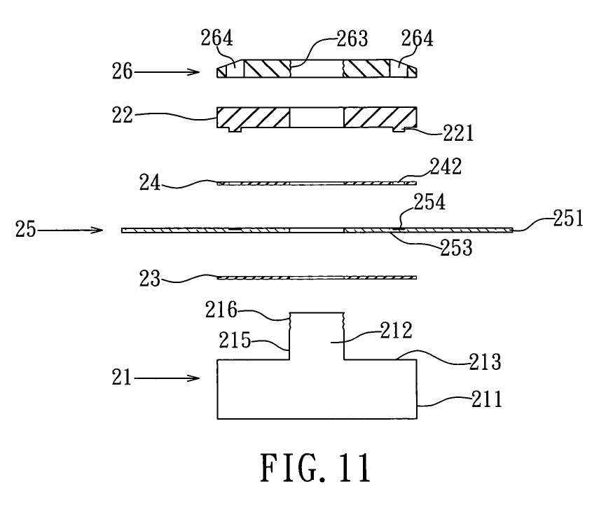

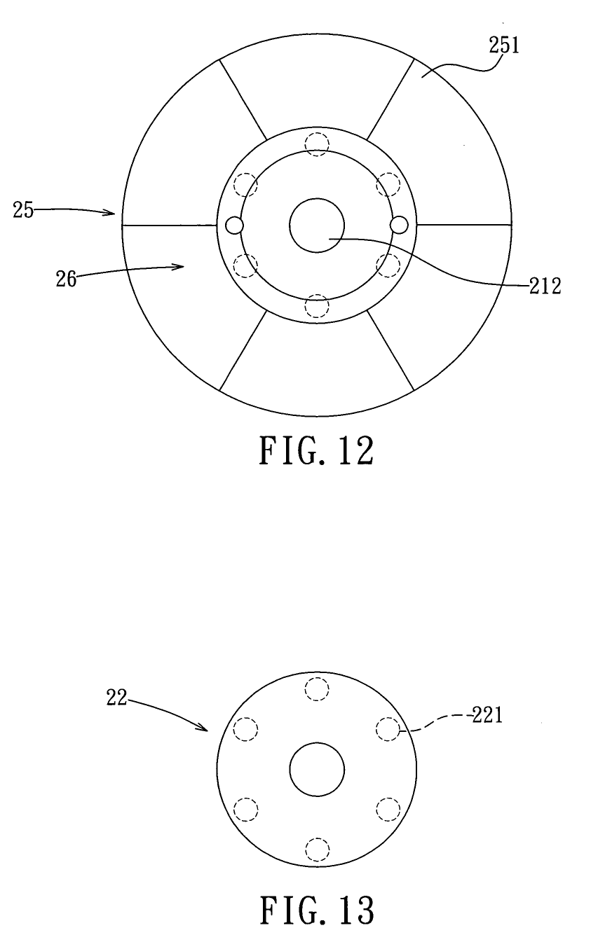

Referring to FIGS. 10, 11 and 12, there is shown a second preferred embodiment of the present invention, which is generally similar to the color wheel 200 shown in FIGS. 3, 4 and 5, but having differences described hereinafter. The engaging portion of the rotating shaft 212 includes an external thread 216 formed on a periphery of a neck portion 215 of the rotating shaft 212, and a pressing ring 22 is additionally provided around the rotating shaft 212 between the second pressing plate 24 and the fixing member 26. Further referring to FIG. 13, the first pressing plate 23, the color filter plate set 25, the second pressing plate 24, and the pressing ring 22 are sleeved around the rotating shaft 212 and are stacked sequentially over the support face 213. The second pressing plate 24 is provided with a plurality of spaced apart through holes 242 for passage of fourth coupling elements 221 of the pressing ring 22. The fourth coupling elements 221 are configured as protrusions. The color filter plates 251 have blind holes as third coupling elements 254. The protrusions or fourth coupling elements 221 engage respectively with the blind holes of third coupling elements 254 through the through holes 242.

The fixing member 26 in the embodiment is an annular disk which has an inner periphery formed with an internal thread 263 to engage with the external thread 216. The annular disk is provided with vent holes 264. The non-resilient annular disk of the fixing member 26 presses the pressing ring 22 against the second pressing plate 24 and the color filter plate set 25. The protrusions or fourth coupling elements 242 engages respectively with the blind holes of the third coupling elements 254 so that the color filter plates 251 are pressed against and flattened over the first pressing plate 23 and the support face 213.

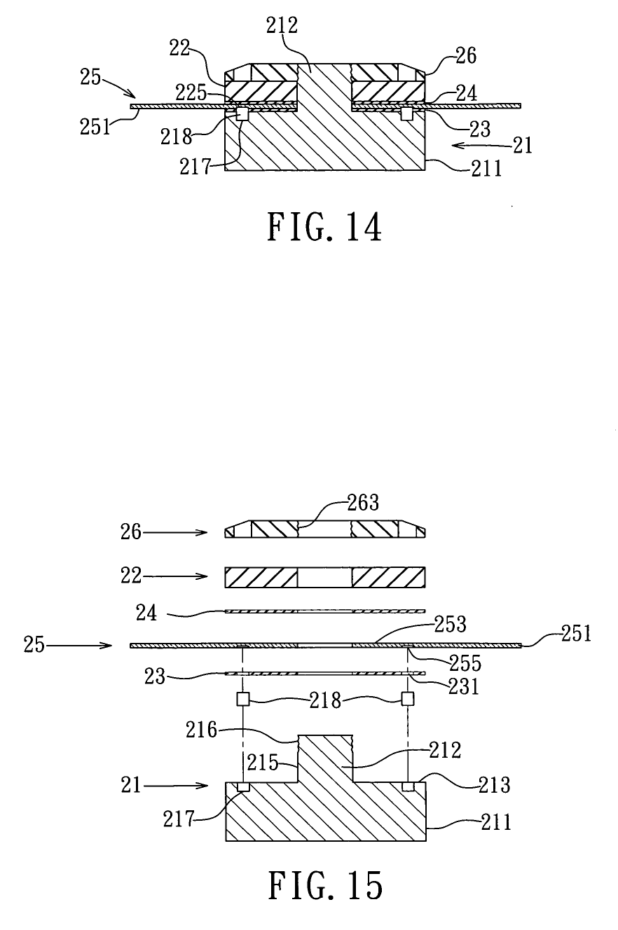

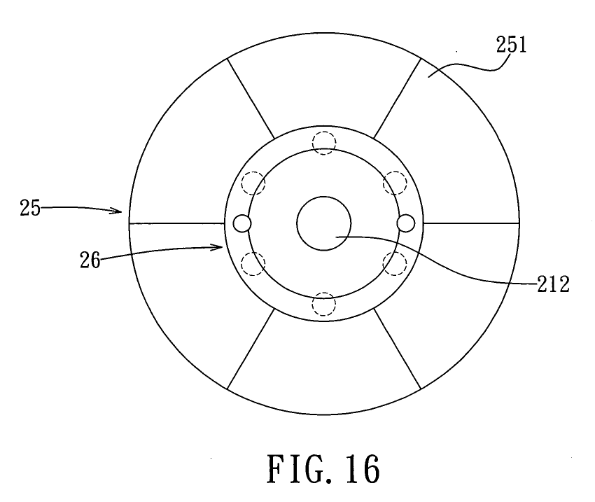

Referring to FIGS. 14, 15, and 16, there is shown the third embodiment of the present invention, which is generally similar to the color wheel shown in FIGS. 10, 11, and 12 but having differences described hereinafter. The support face 213 has a plurality of annularly arranged blind holes 217, and a plurality of sixth coupling elements 218 configured as positioning studs. The positioning studs are fitted respectively in the blind holes 217 of the support face 213. The first pressing plate 23 has six angularly spaced apart slots 231 aligned respectively with the positioning studs 218. The bottom side of each color filter plate 251 is provided with a blind hole as a fifth coupling element 255. The blind holes or fifth coupling elements 255 of the color filter plates 251 are engaged respectively with the positioning studs of sixth coupling elements 218 through the slots 231. The positioning studs 218 in the embodiment are preferably made of a plastic material.

As described above, in the color wheel of the present invention, the rotating shaft 212 is provided with the engaging portion 214, such as the barb, and the external thread 216, and the fixing member 26 is sleeved around the rotating shaft 212 to engage with the engaging portion 214 and to press the second pressing plate 24 which in turn presses the color filter plate set 25 and the first pressing plate 23 against the support face 213. The color filter plate set 25 is therefore held firmly on the support face 213 without the need to use any glue or adhesive. Therefore, the problems encountered by the conventional color wheel due to the use of glue can be alleviated or eliminated.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A color wheel comprising:
a driving unit comprising:
a support face;
a rotating shaft protruding upwardly from a center of said support face; and
an engaging portion formed on said rotating shaft;
a first pressing plate disposed around said rotating shaft and on said support face;
a color filter plate set disposed around said rotating shaft and on said first pressing plate, said color filter plate set including a plurality of angularly arranged color filter plates;
a second pressing plate sleeved around said rotating shaft over said color filter plate set; and
a fixing member disposed around said rotating shaft, said fixing member engaging said engaging portion for pressing said second pressing plate, said color filter plate set, and said first pressing plate against said support face so as to prevent said color filter plate set from moving outwardly from said support face.

2. The color wheel as claimed in claim 1, wherein said engaging portion includes a barb protruding laterally and outwardly from said rotating shaft and formed around a top end of the rotating shaft, and said fixing member includes a resilient annular disk having an inner edge defining a central hole and engaging with said barb.

3. The color wheel as claimed in claim 2, wherein said resilient annular disk is spaced apart from said second pressing plate and further includes a plurality of resilient tabs split from each other and projecting outwardly and downwardly from a periphery of said annular disk to abut against a top side of said second pressing plate.

4. The color wheel as claimed in claim 3, wherein each of said color filter plates has a top face formed with a first coupling element, and said second pressing plate has a plurality of angularly spaced apart second coupling elements formed in a bottom side of said second pressing plate to engage said first coupling elements of said color filter plates, respectively.

5. The color wheel as claimed in claim 4, wherein said first coupling element includes a blind hole, and each of said second coupling elements includes a protrusion for engaging with said blind hole.

6. The color wheel as claimed in claim 4, wherein said first coupling element includes a through hole, and each of said second coupling elements includes a stud for passing through said through hole.

7. The color wheel as claimed in claim 4, wherein each of said color filter plates has a bottom face formed with a roughened surface region adjacent to said rotating shaft to contact and interfere with said first pressing plate.

8. The color wheel as claimed in claim 1, wherein said engaging portion includes an external thread formed on said rotating shaft, and said fixing member includes an inner periphery formed with an internal thread to engage said external thread.

9. The color wheel as claimed in claim 8, further comprising a pressing ring disposed between said second pressing plate and said fixing member.

10. The color wheel as claimed in claim 9, wherein said color filter plates have top faces formed with third coupling elements, respectively, said second pressing plate having a plurality of annularly arranged through holes respectively aligned with said third coupling elements, said pressing ring having a plurality of annularly arranged forth coupling elements respectively aligned with said through holes, engaging said third coupling elements, and passing through said through holes.

11. The color wheel as claimed in claim 10, wherein each of said third coupling elements includes a blind hole, and each of said fourth coupling elements includes a protrusion for engaging said blind hole.

12. The color wheel as claimed in claim 10, wherein each of said third coupling elements includes a through hole, and each of said fourth coupling elements includes a stud passing through said through hole.

13. The color wheel as claimed in claim 9, wherein each of said color filter plates has a bottom face formed with a roughened surface region to contact and interfere with said first pressing plate.

14. The color wheel as claimed in claim 9, wherein said color filter plates have bottom faces formed with fifth coupling elements, respectively, said first pressing plate has a plurality of angularly spaced apart slots respectively aligned with said fifth coupling elements, and said support face includes a plurality of sixth coupling elements engaging said fifth coupling elements and passing through said slots, respectively.

15. The color wheel as claimed in claim 14, wherein each of said fifth coupling elements includes a blind hole, and each of said sixth coupling element includes a positioning stud to engage said blind hole.

16. The color wheel as claimed in claim 14, wherein each of said fifth coupling elements includes a through hole, and each of said sixth coupling elements includes a positioning stud to pass through said through hole.

17. The color wheel as claimed in claim 1, wherein said first pressing plate, said color filter set, said second pressing plate, and said fixing member are sleeved around said rotating shaft and stacked sequentially over said support face.

18. A color wheel, comprising:
a driving unit, comprising:
a rotary housing;
a rotating shaft disposed on a center of said rotary housing; and
an engaging portion formed on said rotating shaft;
at least one pressing plate sleeved around said rotating shaft;
a color filter plate set disposed around said rotating shaft and including a plurality of color filter plates; and
a fixing member disposed around said rotating shaft, said fixing member engaging said engaging portion for pressing said pressing plate and said color filter plate set against said support face so as to prevent said color filter plate set from moving outwardly from said support face.

19. The color wheel as claimed in claim 18, wherein each of said color filter plates has a top side formed with a first coupling element, said pressing plate having a plurality of angularly spaced apart second coupling elements formed on a bottom side of said pressing plate to engage said first coupling elements of said color filter plates, respectively.
